(19) United States
(12) Patent Application Publication
(10) Pub. No.: US 2018/0178764 A1
(43) Pub. Date: Jun. 28, 2018

(54) WHEEL BRAKE PAD

(71) Applicant: QINGDAO RUNBELL CO., LTD., Qiingdao (CN)

(72) Inventor: LI-JUN HU, QINGDAO CITY (CN)

(21) Appl. No.: 15/389,935

(22) Filed: Dec. 23, 2016

(51) Int. Cl. B60T 3/00

(52) U.S. Cl. CPC B60T 3/00

(57) ABSTRACT

A wheel brake pad has a base plate, an inner plate and a cover plate. The first and second ends of the base plate are provided with holes, lower ends of the cover plate and the inner plate are provided with the holes. The lower end of the cover plate and first end of the base plate are connected by inserting a shaft through the holes thereof. The lower end of the inner plate and the second end of the base plate are connected by inserting shaft through the holes thereof. The length of the inner plate is less than that of the cover plate, an upper end of the cover plate is provided with holes, an upper end of the inner plate is provided with a plurality of metal plugs, and the metal plug may be inserted into the hole of the upper end of the cover plate.

### BACKGROUND OF THE INVENTION

### 1. Field of the Invention

The present invention relates to the field of a car accessory, in particular to a wheel brake pad.

### 2. Description of the Related Art

A wheel brake pad is also known as a tire locator, a tire slip stopper and a car slip stopper. Generally, the wheel brake pad is made of high-strength rubber or polymer plastic, the wheel brake pad is mainly used to be placed between a car wheel and the ground when a car is parked, thus being able to effectively prevent the car from skidding and returning back, especially when the car is parked in the case of bad road conditions and in the case that a driver is not in a driving cab, the wheel brake pad can effectively improve traffic safety. Furthermore, the wheel brake pad is also widely used for the driver to solve predicament and repair the vehicle when the vehicle cannot be driven due to mechanical failure. Meanwhile, the wheel brake pad can play a supporting role in the brake by itself.

At present, the wheel brake pad has a simple structure, occupies a large space, and is not convenient for storage and carrying. Therefore, there is an urgent need to have a collapsible device which can prevent a tire from rolling, can stop the slip and is easy to carry.

### SUMMARY OF THE INVENTION

The technical problem to be solved by the present invention is how to overcome the shortcomings in the prior art and provide a wheel brake pad.

To realize the above purpose, the present invention adopts the following technical solution: a wheel brake pad comprises three supporting plates and two shafts, a head of the supporting plate is connected to and a tail of another one supporting plate, such that the three supporting plates are combined to form a triangle, and the three supporting plates comprise a base plate, an inner plate, and a cover plate, wherein a first end and a second end of the base plate are both provided with holes, lower ends of the cover plate and the inner plate are both provided with holes, the lower end of the cover plate and first end of the base plate are connected by inserting the shaft through the holes thereof, the lower end of the inner plate and the second end of the base plate are connected by inserting the other one shaft through the holes thereof, the length of the inner plate is less than that of the cover plate, an upper end of the cover plate is provided with a plurality of holes, an upper end of the inner plate is provided with a plurality of metal plugs, the metal plug is used to be inserted into the hole of the upper end of the cover plate.

Furthermore, the base plate is provided with a plurality of lateral partition plates thereon, a groove is formed between the neighbor two lateral partition plates, first and second ends of the lateral partition plates are both provided with the holes of the base plate, the lower end of the cover plate is provided with a plurality of ring-shaped connection pieces, the ring-shaped connection piece is provided with the hole of the lower end of the cover plate thereon, the ring-shaped connection pieces are inserted into the grooves of the cover plate, and the holes on the ring-shaped connection pieces are aligned with the holes of first ends of the lateral partition plates.

Furthermore, an axle center of the ring-shaped connection piece is flushed with or lower than a lower edge of the cover plate.

Furthermore, a lower surface of the inner plate is provided with a plurality of lateral partition strips, and lower ends of the lateral partition strips are round-cake-shaped and provided with the holes of the inner plate thereon.

Furthermore, a groove is provided between the neighbor two lateral partition strips, the lateral partition plate is inserted into the groove between the corresponding neighbor two lateral partition strips, the lateral partition strip is inserted into the groove of the corresponding neighbor two lateral partition plates.

Furthermore, the metal plug is mounted at an upper end of the lateral partition strip.

Furthermore, the base plate and the cover plate are blocked and combined together, in addition, the inner plate and the base plate are intertwined together so that the whole device is folded together, thereby occupying a small area and being able to be carried conveniently.

Furthermore, a lower surface of the base plate is provided with strip-shaped texture so that a tire may directly contact it, thereby having a proper design.

The present invention is cleverly designed, has a folding manner, does not occupy space and is easy to carry. This application adopts classic triangle stress, has a big bearing force and is stable, thus greatly reducing a potential safety hazard. The invention has innovative idea and design, is scientific and rational, has good use effect, has good promotional value and has great market economic prospects.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a structure diagram of a cover plate 3 of the wheel brake pad in the invention.

FIG. 2 is a structure diagram of a base plate 1 of the wheel brake pad in the invention.

FIG. 3 is a structure diagram of an inner plate 2 of the wheel brake pad in the invention.

FIG. 4 is an overall structure diagram of the wheel brake pad in the invention.

FIG. 5 is a diagram of a use state of the wheel brake pad in the invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

It will be understood that, although the terms first, second, third, etc., may be used herein to describe various elements, these elements should not be limited by these terms. These terms are only used to distinguish one element from another element. Thus, a first element could be termed a second element without departing from the teachings of the invention.

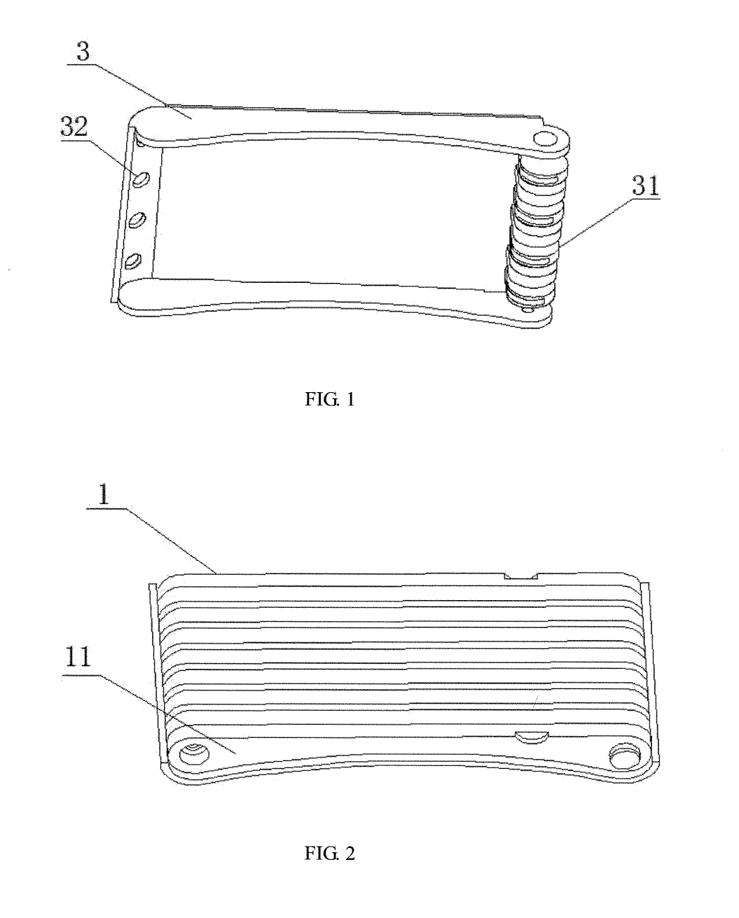

As shown in FIGS. 1-5, a wheel brake pad comprises three supporting plates, a head of one supporting plate is connected to a tail of another one supporting plate, such that the three supporting plates are combined to form a triangle and bear the weight of a tire. The three supporting plates comprise a base plate 1, an inner plate 2 and a cover plate 3. Lower surfaces of the base plate 1, the inner plate 2 and the cover plate 3 are all cambered surfaces which upwards protrude, therefore, the tire is conveniently fixed and locked, thereby preventing the tire from rotating.

The connection and constitutions of the above three supporting plates are described as follows. As shown in FIG. 2, eight lateral partition plates 11 are provided on the base plate 1, a groove is formed between two neighbor ones of the eight lateral partition plates 11, two holes are provided at the first and second ends of each lateral partition plate 11 (p.s. the first and second ends are at two opposite sides of the lateral partition plate 11), such that a shaft can be sued to conveniently connect the inner plate 2 and the cover plate 3 to the base plate 1. Furthermore, the lower surface of base plate 1 may have strip-shaped texture.

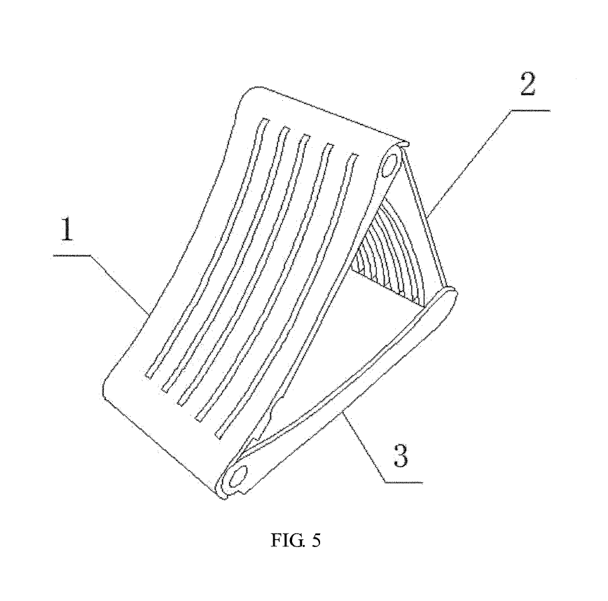

As shown in FIG. 1, a lower end of the cover plate 3 is provided with nine ring-shaped connection pieces 31, the nine ring-shaped connection pieces 31 are provided with the hole thereon; an axle center of the above ring-shaped connection piece 31 is flushed with or lower than a lower edge of the cover plate 3 (p.s. the ring-shaped connection piece 31 contacts the lower edge of the cover plate 3). Each above ring-shaped connection piece 31 may be inserted into the groove between corresponding neighbor two lateral partition plates 11. Meanwhile, the holes on the ring-shaped connection pieces 31 are aligned with the holes at the first ends of the lateral partition plates 11 for the convenient insertion of a shaft, therefore, the cover plate 3 and the base plate 1 are moved around the shaft. The above cover plate 3 may completely be blocked and fastened on the base plate 1 to form a form similar to a box (as shown in FIG. 4), thus saving space.

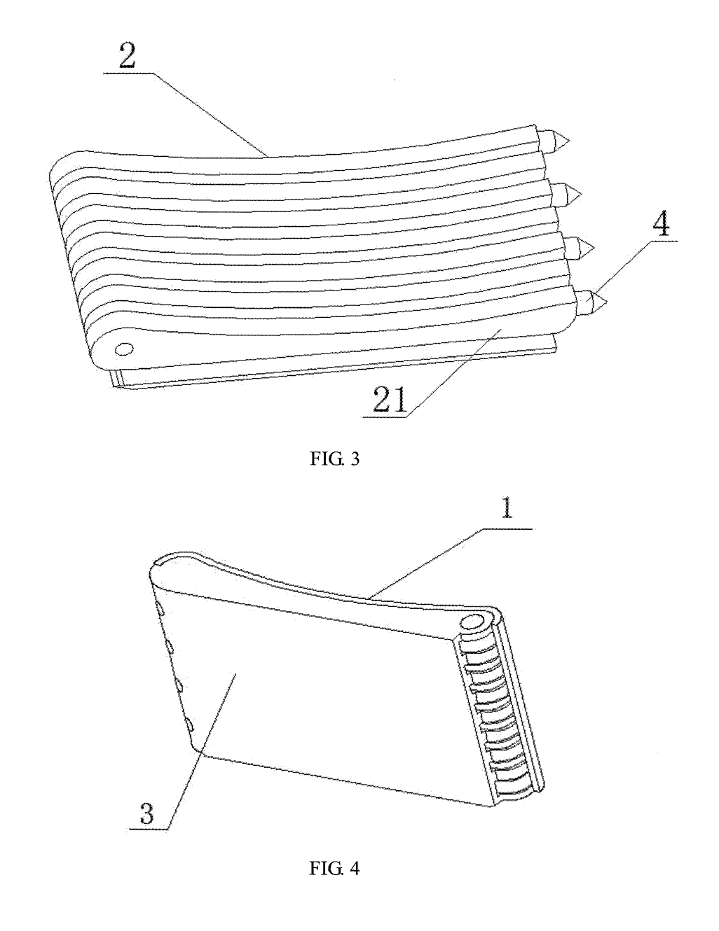

As shown in FIG. 3, the lower surface of the inner plate 2 is provided with seven lateral partition strips 21, a lower end of the lateral partition strip 21 is round-cake-shaped and provided with a hole there on. A groove is provided between each neighbor two lateral partition strips 21, the lateral partition plate 11 may be inserted into the groove between the corresponding neighbor two lateral partition strips 21, and the lateral partition strip 21 is inserted into the groove of corresponding neighbor two lateral partition plates 11. Therefore, the inner plate 2 and the base plate 1 are intertwined together, presenting a folding manner. Meanwhile, the holes of the lower ends of the lateral partition strips 21 and the holes of the second ends of the base plate 1 are aligned with each other and connected by a way that a shaft is inserted through the above aligned holes.

In the above structure, the length of the inner plate 2 is less than that of the base plate 1, so that when the above cover plate 3 is completely blocked and fastened on the base plate 1, the inner plate 2 can be completely folded in an inner portion thereof, thus having a proper design manner.

In order to make the base plate 1, the inner plate 2 and the cover plate 3 present a triangle fixing mode, an upper end of the inner plate 2 is provided with four metal plugs 4, more precisely, the metal plug 4 is mounted at an upper end of the lateral partition strip 21, an upper end of the cover plate 3 is provided with four holes 32, and the metal plug 4 is inserted into the through the hole 32, to realize a triangle fixing mode of the base plate 1, the inner plate 2 and the cover plate 3.

For the present wheel brake pad, the base plate 1 and the cover plate 3 are blocked and combined together. In addition, the inner plate 2 and the base plate 1 are intertwined together so that the whole device is folded together, thereby occupying a small area and being able to be carried conveniently (as shown in FIG. 4).

As shown in FIG. 5, when the user want to use present wheel brake pad, the cover plate 3 is opened, then the inner plate 2 is opened from the base plate 1, and next, the metal plug 4 on the inner plate 2 is inserted into the hole 32. Thus, the present wheel brake pad is turned over so that the above cover plate 3 is positioned at a base portion thereof, as a stressed surface (for example, the ground), the base plate 1 is used for bearing the pressure from a car wheel, thus having cleverly design.

The above examples are only used for describing the technical conception and features of the present invention, its purpose is to let the ordinary persons skilled in the art be capable of understanding the content of the invention and carrying out the invention, without limiting the protection scope of the invention. All of changes or modifications made according to the substance of the content of the invention shall be within the protection scope of the invention.

What is claimed is:

1. A wheel brake pad, comprising three supporting plates and two shafts, wherein a head of the supporting plate is connected to and a tail of another one supporting plate, such that the three supporting plates are combined to form a triangle, and the three supporting plates comprise:
a base plate;
an inner plate; and
a cover plate;
wherein a first end and a second end of the base plate are both provided with holes, lower ends of the cover plate and the inner plate are both provided with holes, the lower end of the cover plate and first end of the base plate are connected by inserting the shaft through the holes thereof, the lower end of the inner plate and the second end of the base plate are connected by inserting the other one shaft through the holes thereof, the length of the inner plate is less than that of the cover plate, an upper end of the cover plate is provided with a plurality of holes, an upper end of the inner plate is provided with a plurality of metal plugs, the metal plug is used to be inserted into the hole of the upper end of the cover plate.

2. The wheel brake pad according to claim 1, wherein the base plate is provided with a plurality of lateral partition plates thereon, a groove is formed between the neighbor two lateral partition plates, first and second ends of the lateral partition plates are both provided with the holes of the base plate, the lower end of the cover plate is provided with a plurality of ring-shaped connection pieces, the ring-shaped connection piece is provided with the hole of the lower end of the cover plate thereon, and the ring-shaped connection pieces are inserted into the grooves of the cover plate, the holes on the ring-shaped connection pieces are aligned with the holes of the first ends of the lateral partition plates.

3. The wheel brake pad according to claim 1, wherein an axle center of the ring-shaped connection piece is flushed with or lower than a lower edge of the cover plate.

4. The wheel brake pad according to claim 1, wherein a lower surface of the inner plate is provided with a plurality of lateral partition strips, and lower ends of the lateral partition strips are round-cake-shaped and provided with the holes of the inner plate thereon.

5. The wheel brake pad according to claim 4, wherein a groove is provided between the neighbor two lateral partition strips, the lateral partition plate is inserted into the groove between the corresponding neighbor two lateral partition strips, the lateral partition strip is inserted into the groove of the corresponding neighbor two lateral partition plates.

6. The wheel brake pad according to claim 1, wherein the metal plug is mounted at an upper end of the lateral partition strip.

7. The wheel brake pad according to claim 1, wherein the base plate and the cover plate are blocked and combined together.

8. The wheel brake pad according to claim 1, wherein a lower surface of the base plate is also provided with strip-shaped texture.
